(19) United States
(12) Patent Application Publication
(10) Pub. No.: US 2003/0059166 A1
(43) Pub. Date: Mar. 27, 2003

(54) Planar type light emitting and receiving component having high light gathering efficiency

(76) Inventor: Cheng-Bin Wang, Kaohsiung City (TW)

Correspondence Address: Hart, Baxley, Daniels & Holton, Fifth Floor, 59 John Street, New York, NY, 10038, US

(21) Appl. No.: 09/957,499

(22) Filed: Sep. 21, 2001

(51) Int. Cl. G02B 6/30

(52) U.S. Cl. 385/49

(57) ABSTRACT

The present invention is to provide a planar type light emitting and receiving component having a high light gathering efficiency, and including a substrate provided with a epitaxy growth layer and formed with a cavity, an active region provided in the epitaxy growth layer for emitting light, and a light gathering lens formed in the cavity and located close to the active region of the epitaxy growth layer. Thus, the distance between the active region and the light gathering face may be shortened, thereby efficiently gathering the light.

### BACKGROUND OF THE INVENTION

1. Field of the Invention

The present invention relates to a planar type light emitting and receiving component having a high light gathering efficiency, that may be coupled with an optical fiber.

2. Description of the Related Art

A conventional light emitting and receiving component 31 shown in FIG. 1 is coupled with an optical fiber 41. The light emitting and receiving component 31 includes an active region 33 that is provided in a epitaxy growth layer 32 of a few micrometers (μm) for emitting light. A substrate 34 is connected with the epitaxy growth layer 32, and a light gathering face 35 is protruded outward from a side of the substrate 34, and is far spaced from the epitaxy growth layer 32. The light gathering face 35 that is directly made on the substrate 34 may be mass produced during a batch process, and may facilitate the control of the component feature, and control of the evenness of the entire wafer, thereby efficiently decreasing the cost.

The thickness of the substrate 34 is about hundreds of μm, and the thickness of the epitaxy growth layer 32 is about a few μm, so that the thickness of the substrate 34 is mush greater than that of the epitaxy growth layer 32. Further, the light gathering face 35 is protruded outward from the substrate 34, so that the light gathering face 35 is far spaced from the active region 33.

Thus, when in use, the light (as indicated by arrows) of the active region 33 may be reflected and focused through the light gathering face 35 to enter the core 42 of the optical fiber 41. However, the light gathering face 35 is far spaced from the active region 33, so that many beams of light scatter, thereby greatly decreasing the light gathering effect.

Another conventional light emitting and receiving component 51 in accordance with the prior art shown in FIG. 2 is coupled with an optical fiber 41. The light emitting and receiving component 51 includes a epitaxy growth layer 52 having an active region 53 for emitting the light. A substrate 54 is connected with the epitaxy growth layer 52, and a convex-shaped light gathering face 55 is etched on the surface of the substrate 54, and is far spaced from the epitaxy growth layer 52.

In comparison, the light gathering face 55 as shown in FIG. 2 is slightly closer to the active region than the light gathering face 35 as shown in FIG. 1. However, the top of the light gathering face 55 is flush with the surface of the substrate 54. That is, the light gathering face 55 is far spaced from the active region 53, thereby greatly decreasing the light gathering effect.

The substrate 34 or 54 may be made to have a thin-shape, so that the light gathering face 35 or 55 is closer to the active region 33 or 53. However, after the wafer is made, the light emitting and receiving component 31 or 51 needs to be cut into crystal particles. Thus, if the substrate 34 or 54 is made to have a thin-shape, the wafer is easily broken in the following manufacturing process. In addition, during the cutting process, the wafer is easily broken due to the stress effect, thereby decreasing the quality of the product. Therefore, reduction of thickness of the substrate 34 or 54 may enhance the feature of the component, but cannot satisfy the practical requirements of the manufacturing process.

### SUMMARY OF THE INVENTION

The primary objective of the present invention is to provide a planar type light emitting and receiving component having a high light gathering efficiency, comprising: a substrate provided with a epitaxy growth layer and formed with a cavity, an active region provided in the epitaxy growth layer for emitting light, a convex-shaped light gathering face formed in the cavity and located close to the active region of the epitaxy growth layer. Thus, the distance between the active region and the light gathering face may be greatly shortened, thereby efficiently gathering the light. Thus, the light emitted from the active region may be focused by the light gathering face immediately, thereby increasing the light gathering effect. In addition, the thickness of the substrate needs not to be changed, thereby maintaining the completeness of the crystal particles, and thereby increasing the quality of the manufacturing process.

Further benefits and advantages of the present invention will become apparent after a careful reading of the detailed description with appropriate reference to the accompanying drawings.

### BRIEF DESCRIPTION OF THE DRAWINGS

FIG. 1 is a schematic view of a conventional light emitting and receiving component coupled with an optical fiber in accordance with the prior art;

FIG. 2 is a schematic view of another conventional light emitting and receiving component coupled with an optical fiber in accordance with the prior art;

FIG. 3 is top plan view of a planar type light emitting and receiving component having a high light gathering efficiency in accordance with the present invention;

FIG. 4 is a cross-sectional view of the planar type light emitting and receiving component having a high light gathering efficiency taken along line 4-4 as shown in FIG. 3; and

FIG. 5 is a schematic view of the planar type light emitting and receiving component having a high light gathering efficiency coupled with an optical fiber.

### DETAILED DESCRIPTION OF THE INVENTION

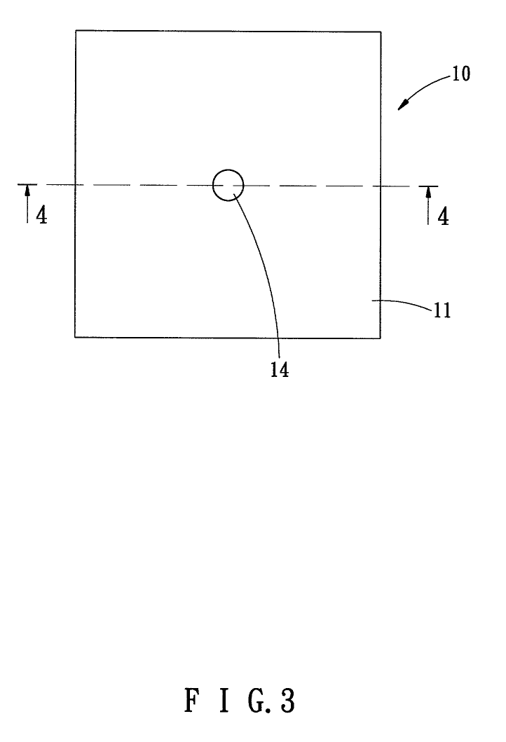

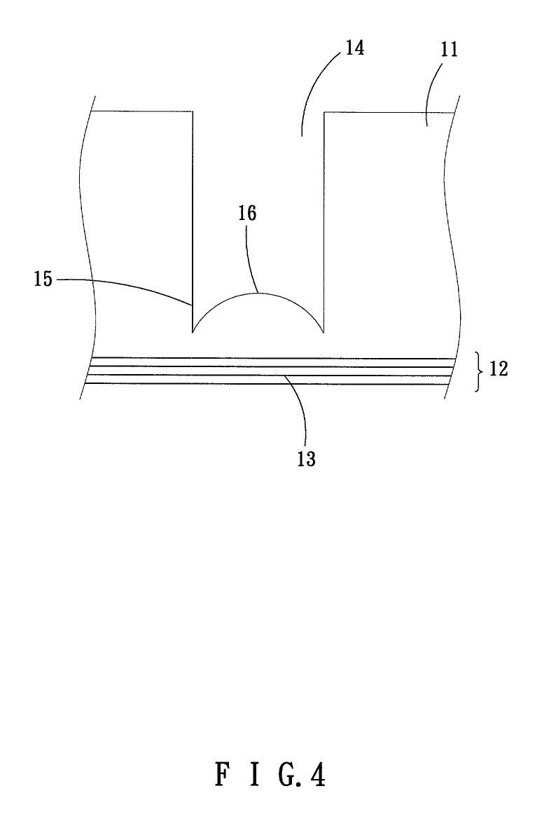

Referring to the drawings and initially to FIGS. 3 and 4, a planar type light emitting and receiving component 10 having a high light gathering efficiency in accordance with a preferred embodiment of the present invention comprises a substrate 11 having a surface provided with a epitaxy growth layer 12 that is made of a compound semi-conductor. An active region 13 is provided in the epitaxy growth layer 12 for emitting light. The light emitted from the active region 13 may penetrate through the substrate 11.

A cavity 14 is etched in the substrate 11, and has an area much smaller than that of the substrate 11 as shown in FIG. 3. The bottom 15 of the cavity 14 is integrally formed with a lens face during the etching process. The lens face may be a light gathering face 16 having a convex shape. The light gathering face 16 may be very close to the epitaxy growth layer 12, so that the distance between the light gathering face 16 and the active region 13 is much shorter.

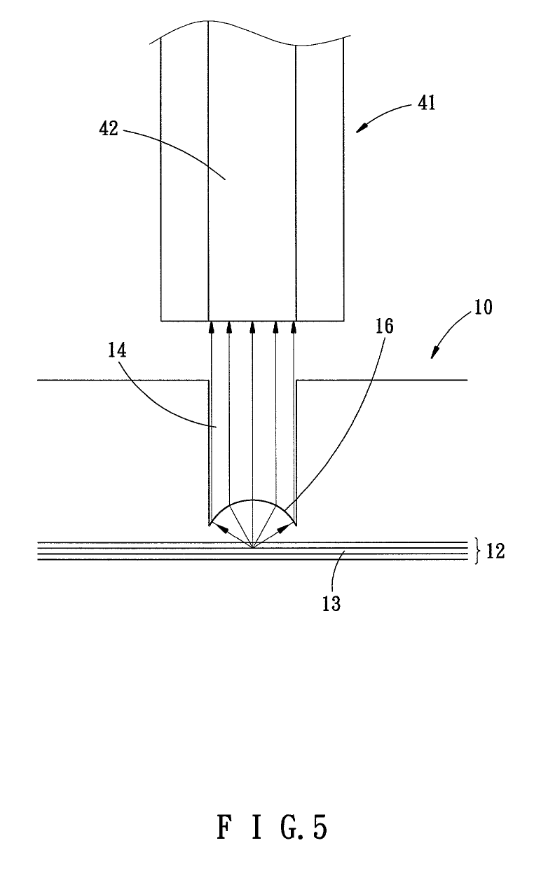

As shown in FIGS. 4 and 5, the light gathering face 16 in the cavity 14 is close to the epitaxy growth layer 12. Thus, when the planar type light emitting and receiving component 10 is coupled with the optical fiber 41, and the active region 13 emits light, the light may reach the light gathering face 16 in a very short optical path. Thus, the light gathering face 16 may gather and focus the light emitted from the active region 13 before the light scatters largely, so that the light may be highly gathered, and the penetrating light may exactly enter the core 42 of the optical fiber 41.

The thickness of the substrate 11 may exceed 350 μm. Traditionally, the etching velocity is about 2 to 3 μm. Thus, it is necessary to take a long time to etch a cavity 14 having a depth of 300 μm in the substrate 11, so that the distance between the light gathering face 16 and the epitaxy growth layer 12 is about 50 μm. Recently, a more rapid etching technology, such as the high density plasma reactive ion etching (HDP-RIE) technology, may provide an etching speed greater than 10 μm/min. Thus, it only needs to take about thirty minutes to etch a cavity 14 having a depth of 300 μm in the substrate 11, so that the etching time is apparently shortened largely, thereby fully satisfying the practical requirements of the manufacturing process.

Of course, the substrate 11 may be made to have a thin-shape under the condition that it may withstand the cutting force, thereby shortening the etching time so that the distance between the light gathering face 16 and the epitaxy growth layer 12 is about 50 μm, thereby fully satisfying the practical requirements of the manufacturing process.

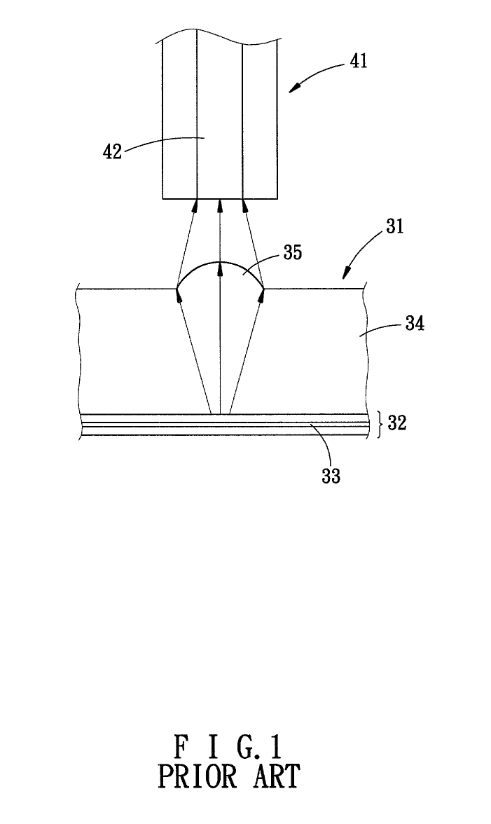

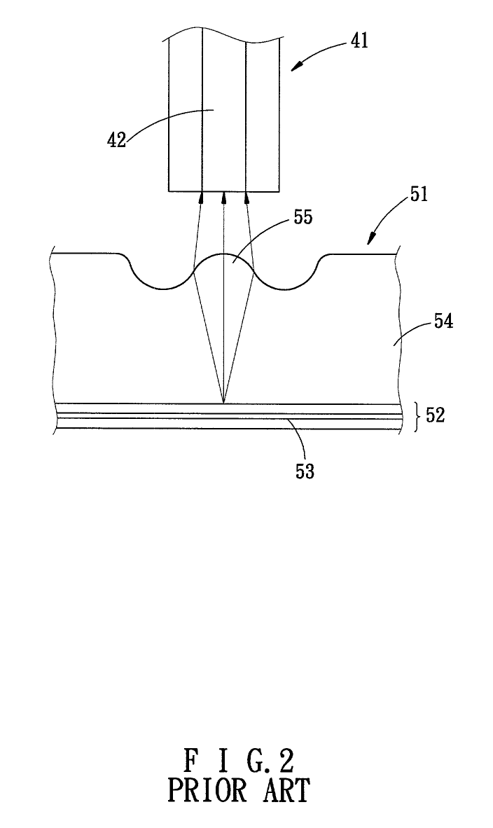

In comparison, the light gathering face 16 as shown in FIG. 5 is much closer to the active region 13 than the light gathering face 35 as shown in FIG. 1 and the light gathering face 55 as shown in FIG. 2, such that the present invention may provide a shorter optical path for the active region 13, thereby enhancing the light gathering effect.

In addition, during the process of cutting the crystal particles, the area of the cavity 14 (i.e., the active region) is very small without affecting the strength of the substrate 11, thereby increasing the quality of cutting the crystal particles, so as to satisfy the requirements of the manufacturing process.

In addition, during the process of etching the cavity 14, the bottom 15 of the cavity 14 is integrally formed with the light gathering face 16, thereby satisfying the requirements of production and fabrication without needing an additional manufacturing process.

When the optical fiber 41 is used, it is necessary to provide a light emitting component on one side of the optical fiber 41, and to provide a light receiving component on the other side of the optical fiber 41. Thus, the light signal emitted from the light emitting component is transmitted through the optical fiber 41, and is received by the light receiving component. In the above embodiment, the light emitting and receiving component 10 may emit the light toward one side of the optical fiber 41. At this time, the light emitting and receiving component 10 functions as a light emitting component. Similarly, the light emitting and receiving component 10 may be provided on the other side of the optical fiber 41, such that the light signal transmitted through the optical fiber 41 may be received by the light emitting and receiving component 10. At this time, the light emitting and receiving component 10 functions as a light receiving component. The light emitting and receiving component 10 may co-operate with the light gathering face 16 so as to enhance the effect of receiving the light signal.

The lens face disclosed in the above embodiment is a light gathering face 16 having the effect of a convex lens, and the light gathering face 16 is close to the active region 13, so that the light of the active region 13 may further enhance the focusing effect. In such a manner, the light emitting and receiving component may be formed with a cavity which my be formed with a lens face (such as a concave lens) that may diverge the light. Thus, the active region 13 may attenuate the energy of the light through the concave lens, and then the light signal may be transmitted toward the optical fiber.

While the preferred embodiment of the present invention has been shown and described, it will be apparent to those skilled in the art that various modifications may be made in the embodiment without departing from the spirit of the present invention. Such modifications are all within the scope of the present invention.

What is claimed is:

1. A planar type light emitting and receiving component having a high light gathering efficiency, comprising: a substrate provided with a epitaxy growth layer and formed with a cavity, an active region provided in the epitaxy growth layer for emitting light, a lens face formed in the cavity and located close to the active region of the epitaxy growth layer.

2. The planar type light emitting and receiving component having a high light gathering efficiency in accordance with claim 1, wherein the lens face is a light gathering face having a convex shape.

3. The planar type light emitting and receiving component having a high light gathering efficiency in accordance with claim 1, wherein the lens face is formed on a bottom of the cavity.

4. The planar type light emitting and receiving component having a high light gathering efficiency in accordance with claim 1, wherein the lens face is integrally formed when the cavity is etched on the substrate.

5. The planar type light emitting and receiving component having a high light gathering efficiency in accordance with claim 1, wherein the lens face is a light diverging face having a concave shape.
